(19) United States
(12) Patent Application Publication
(10) Pub. No.: US 2009/0128619 A1
(43) Pub. Date: May 21, 2009

(54) SIGNAL PROCESSING SYSTEM FOR SYNTHESIZING HOLOGRAMS

(75) Inventor: Peter William Tudor Mash, Staffordshire (GB)

Correspondence Address: KNOBBE MARTENS OLSON & BEAR LLP, 2040 MAIN STREET, FOURTEENTH FLOOR, IRVINE, CA, 92614, US

(73) Assignee: Light Blue Optics Ltd.

(21) Appl. No.: 11/917,490

(22) PCT Filed: Jun. 13, 2006
(86) PCT No.: PCT/GB2006/050152

§ 371 Date: Nov. 19, 2008

(30) Foreign Application Priority Data
Jun. 14, 2005 (GB) 0511962.3
Jun. 27, 2005 (GB) 0512905.1

(51) Int. Cl. H04N 5/89; G09G 5/36

(52) U.S. Cl. 348/40; 345/545

(57) ABSTRACT

This invention relates to hardware acceleration of signal processing systems for displaying an image using holographic techniques. A hardware accelerator for a holographic image display system, the image display system being configured to generate a displayed image using a plurality of holographically generated temporal subframes, said temporal subframes being displayed sequentially in time such that they are perceived as a single reduced-noise image, each said subframe being generated holographically by modulation of a spatial light modulator with holographic data such that replay of a hologram defined by said holographic data defines a said subframe, the hardware accelerator comprising: an input buffer to store image data defining said displayed image; an output buffer to store holographic data for a said subframe; at least one hardware data processing module coupled to said input data buffer and to said output data buffer to process said image data to generate said holographic data for a said subframe; and a controller coupled to said at least one hardware data processing module to control said at least one data processing module to provide holographic data for a plurality of said subframes corresponding to image data for a single said displayed image to said output data buffer.

### FIELD OF THE INVENTION

This invention relates to hardware acceleration of signal processing systems for displaying an image using holographic techniques.

### BACKGROUND TO THE INVENTION

We have previously described, in UK Patent Application No. GB0329012.9, filed 15 Dec. 2003, now published as WO2005/059881 (hereby incorporated by reference in its entirety), a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms.

Broadly speaking embodiments of the method aim to display an image by projecting light via a spatial light modulator (SLM) onto a screen. The SLM is modulated with holographic data approximating a hologram of the image to be displayed but this holographic data is chosen in a special way, the displayed image being made up of a plurality of temporal subframes, each generated by modulating the SLM with a respective subframe hologram. These subframes are displayed successively and sufficiently fast that in the eye of a (human) observer the subframes (each of which have the spatial extent of the displayed image) are integrated together to create the desired image for display.

Each of the subframe holograms may itself be relatively noisy, for example as a result of quantising the holographic data into two (binary) or more phases, but temporal averaging amongst the subframes reduces the perceived level of noise. Embodiments of such a system can provide visually high quality displays even though each subframe, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and a (+1 and −1 for a nomialised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image frames within a limited frame period.

According to the present invention there is therefore provided a hardware accelerator for a holographic image display system, the image display system being configured to generate a displayed image using a plurality of holographically generated temporal subframes, said temporal subframes being displayed sequentially in time such that they are perceived as a single reduced-noise image, each said subframe being generated holographically by modulation of a spatial light modulator with holographic data such that replay of a hologram defined by said holographic data defines a said subframe, the hardware accelerator comprising: an input buffer to store image data defining said displayed image; an output buffer to store holographic data for a said subframe; at least one hardware data processing module coupled to said input data buffer and to said output data buffer to process said image data to generate said holographic data for a said subframe; and a controller coupled to said at least one hardware data processing module to control said at least one data processing module to provide holographic data for a plurality of said subframes corresponding to image data for a single said displayed image to said output data buffer.

Preferably a plurality of the hardware data processing modules is included for processing data for a plurality of the subframes in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile data store. The phase modulator preferably includes at least one multiplier to multiply pixel data from the input data buffer by input phase modulation data. In a simple embodiment the multiplier simply changes a sign of the input data.

In embodiments an output of the phase modulator is provided to a space-frequency transformation module such as a Fourier transform or inverse Fourier transform module. In the context of the holographic subframe generation procedure described later these two operations are substantially equivalent, effectively differing only by a scale factor. In other embodiments other space-frequency transformations may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transformation of the (spatial distribution of the) phase modulated image data to output holographic subframe data. This simplifies the hardware and enables processing of, for example, first rows then columns (or vice versa).

In preferred embodiments the hardware data also includes a quantiser coupled to the output of the transformation module to quantise the holographic subframe data to provide holographic data for a subframe for the output buffer. The quantiser may quantise into two, four or more (phase) levels. In preferred embodiments the quantiser is configured to quantise real and imaginary components of the holographic subframe data to generate a pair of subframes for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of subframes the less the overall noise this provides further benefits.

Preferably one or both of the input and output buffers comprise dual-ported memory.

In some particularly preferred embodiments the holographic image display system comprises a video image display system and the displayed image comprises a video frame.

The invention further provides a holographic image display system including a hardware accelerator as described above.

### BRIEF DESCRIPTION OF THE DRAWINGS

These and other aspects of the invention will now further be described, by way of example only, with reference to the accompanying figures in which:

FIG. 1 shows an outline block diagram of an embodiment of a hardware accelerator for a holographic image display system.

FIG. 2 shows the operations performed within an embodiment of a hardware block as shown in FIG. 1.

FIG. 3 shows the energy spectra of a sample image before and after multiplication by a random phase matrix.

FIG. 4 shows an embodiment of a hardware block with parallel quantisers for the simultaneous generation of two subframes from the real and imaginary components of complex holographic subframe data respectively.

FIG. 5 shows an embodiment of hardware to generate pseudo-random binary phase data and multiply incoming image data, I_{xy}, by the phase values to produce G_{xy}.

FIG. 6 shows an embodiment of hardware to multiply incoming image frame data, I_{xy} by complex phase values, which are randomly selected from a look-up table, to produce phase-modulated image data, G_{xy}.

FIG. 7 shows an embodiment of hardware which performs a 2-D FFT on incoming phase-modulated image data, G_{xy}, by means of a 1-D FFT block with feedback, to produce holographic data guy.

FIG. 8 shows sequential interpretation of RBG bitplanes.

FIG. 9 shows an outline block diagram of further hardware for a holographic image display system.

FIG. 10 shows an example of a hologram replay field including a conjugate image.

FIG. 11 shows a detailed block diagram of hardware for a holographic image display system.

FIG. 12 shows an output collator for use with the holographic image display system of FIG. 11.

FIG. 13 shows conversion from a 4:2:2 to a 4:4:4 sampling scheme.

FIG. 14 illustrates the display of collated data.

FIGS. 15a and 15b show, respectively, a holographic image display system incorporating a hardware accelerator, and a consumer electronic device incorporating the holographic image display system of FIG. 15a.

### DETAILED DESCRIPTION OF PREFERRED EMBODIMENTS

In an embodiment, the various stages of the hardware accelerator implement the algorithm listed below. The algorithm is a method of generating, for each video frame I=I_{xy}, sets of N binary-phase holograms h⁽¹⁾ . . . h^{(N)}. Statistical analysis of the algorithm has shown that such sets of holograms form replay fields that exhibit mutually independent additive noise.
1. Let G_{xy}⁽ⁿ⁾=I_{xy} exp (jφ_{xy}⁽ⁿ⁾) where φ_{xy}⁽ⁿ⁾ is uniformly distributed between 0 and 2π for 1≦n≦N/2 and 1≦x,y≦m
2. Let gᵤᵥ⁽ⁿ⁾≦F⁻¹[G_{xy}⁽ⁿ⁾] where R⁻¹ represents the two-dimensional inverse Fourier transform operator for 1≦n≦N/2
3. Let mᵤᵥ⁽ⁿ⁾= [symbol] gᵤᵥ⁽ⁿ⁾} for 1≦n≦N/2
4. Let mᵤᵥ^{(n+N/2)}= [symbol] {gᵤᵥ⁽ⁿ⁾} for 1≦n≦N/2

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} \\ where {Q}^{( n )} = median ( {m}_{uv}^{( n )} ) \\ and 1 \leq n \leq N \qquad$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ assumed to be zero. This assumption can be shown to be valid and the effects of making this assumption are minimal with regard to perceived image quality. Further details can be found in the applicant's earlier application (ibid), to which reference may be made.

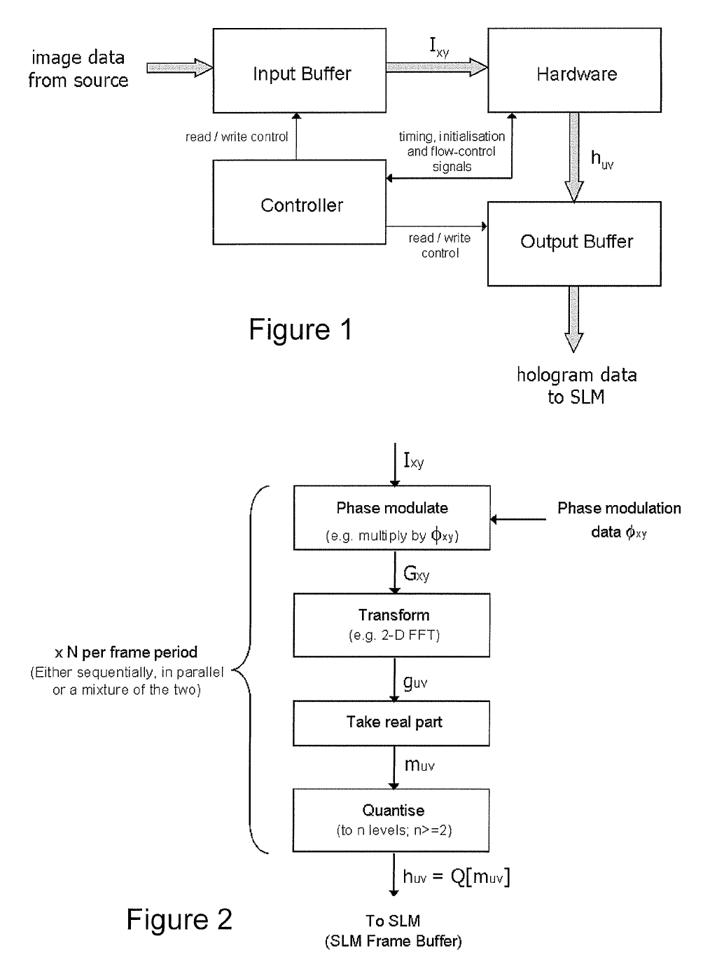

FIG. 1 shows a block diagram of an embodiment of a hardware accelerator for a holographic image display system, The input to the system is preferably image data from a source such as a computer, although other sources are equally applicable. The input data is temporarily stored in one or more input buffer, with control signals for this process being supplied from one or more controller units within the system. Each input buffer preferably comprises dual-port memory such that data is written into the input buffer and read out from the input buffer simultaneously. The output from the input buffer shown in FIG. 1 is an image frame, labelled I, and this becomes the input to the hardware block. The hardware block, which is described in more detail using FIG. 2, performs a series of operations on each of the aforementioned image frames, I, and for each one produces one or more holographic subframes, h, which are sent to one or more output buffer. Each output buffer preferably comprises dual-port memory. Such subframes are outputted from the aforementioned output buffer and supplied to a display device, such as a SLM, optionally via a driver chip. The control signals by which this process is controlled are supplied from one or more controller unit. The control signals preferably ensure that one or more holographic subframes are produced and sent to the SLM per video frame period. In an embodiment, the control signals transmitted from the controller to both the input and output buffers are read/write select signals, whilst the signals between the controller and the hardware block comprise various timing, initialisation and flow-control information.

FIG. 2 shows an embodiment of a hardware block as described in FIG. 1, comprising a set of hardware elements designed to generate one or more holographic subframes for each image frame that is supplied to the block. In such an embodiment, preferably one image frame, I_{xy}, is supplied one or more times per video frame period as an input to the hardware block. The source of such image frames may be one or more input buffers as shown in FIG. 1. Each image frame, I_{xy}, is then used to produce one or more holographic subframes by means of a set of operations comprising one or more of: a phase modulation stage, a space-frequency transformation stage and a quantisation stage. In embodiments, a set of N subframes, where N is greater than or equal to one, is generated per frame period by means of using either one sequential set of the aforementioned operations, or a several sets of such operations acting in parallel on different subframes, or a mixture of these two approaches.

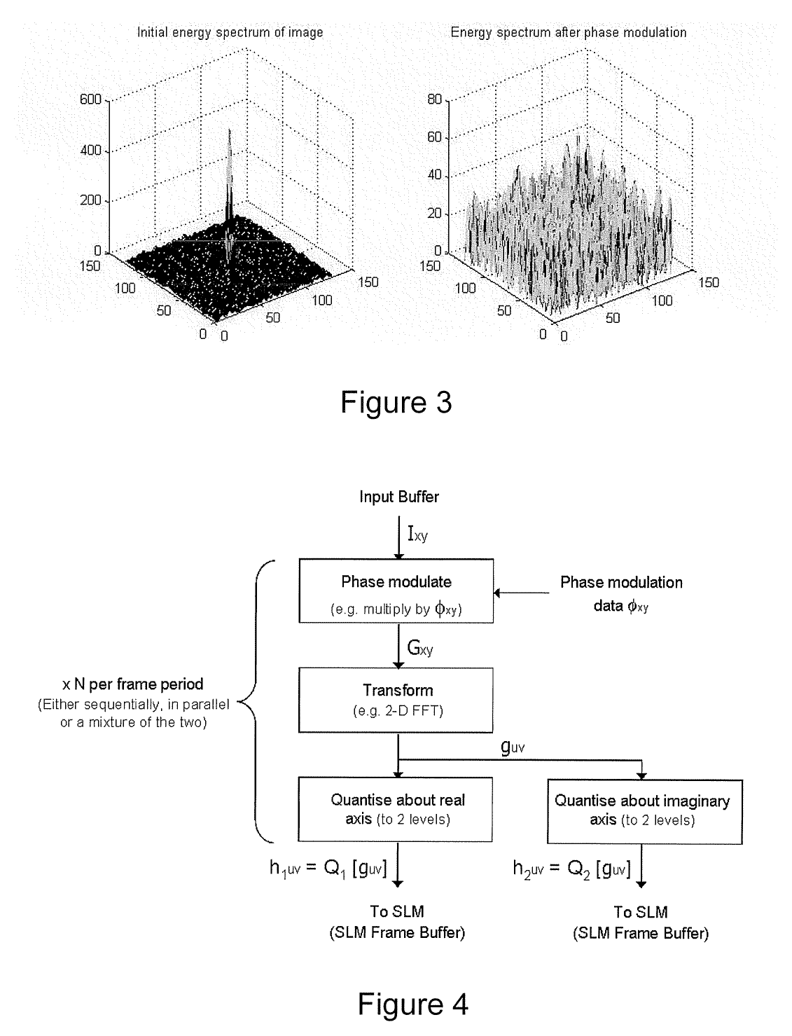

The purpose of the phase-modulation block shown in the embodiment of FIG. 2 is to redistribute the energy of the input frame in the spatial-frequency domain, such that improvements in final image quality are obtained after performing later operations. FIG. 3 shows an example of how the energy of a sample image is distributed before and after a phase-modulation stage in which a random phase distribution is used. It can be seen that modulating an image by such a phase distribution has the effect of redistributing the energy more evenly throughout the spatial-frequency domain.

The quantisation hardware that is shown in the embodiment of FIG. 2 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic subframe data to generate a pair of subframes for the output buffer, each with two phase-retardation levels. It can be shown that for discretely pixilated fields, the real and imaginary components of the complex holographic subframe data are uncorrelated, which is why it is valid to treat the real and imaginary components independently and produce two uncorrelated holographic subframes.

FIG. 4 shows an embodiment of the hardware block described in FIG. 1 in which a pair of quantisation elements are arranged in parallel in the system so as to generate a pair of holographic subframes from the real and imaginary components of the complex holographic subframe data respectively.

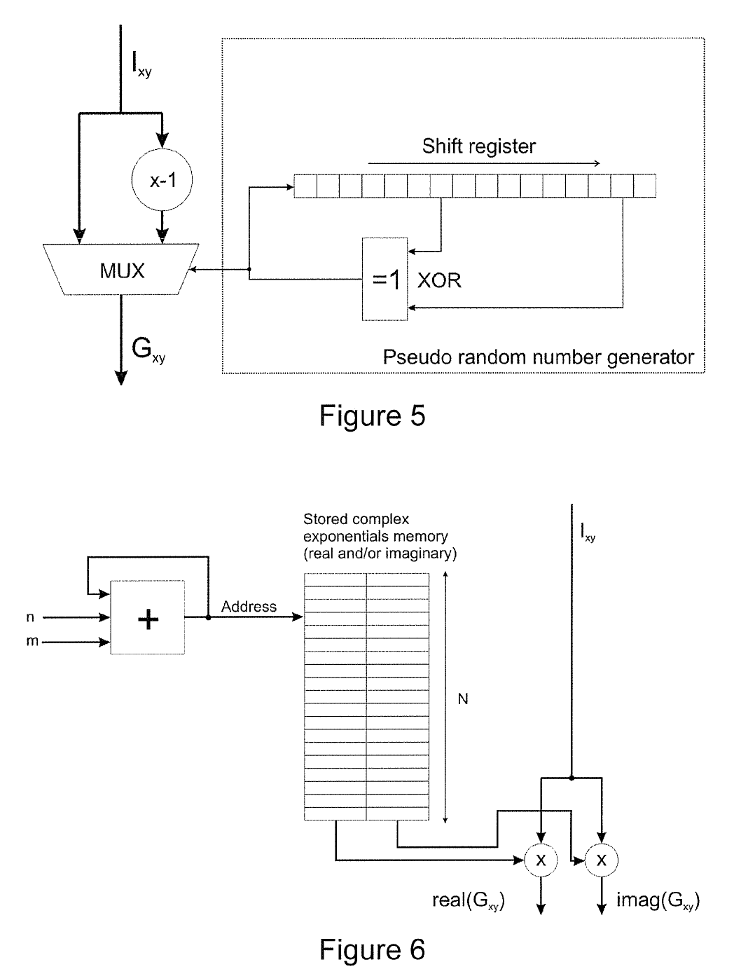

There are many different ways in which phase-modulation data, as shown in FIG. 2, may be produced. In an embodiment, pseudo-random binary-phase modulation data is generated by hardware comprising a shift register with feedback and an XOR logic gate. FIG. 5 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

FIG. 6 shows suitable hardware for such an embodiment, comprising a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic subframe. In another embodiment, the third input, n, is omitted. In a further embodiment, m and N are both chosen to be distinct members of the set of prime numbers, which is a strong condition guaranteeing that the sequence of address values is truly random.

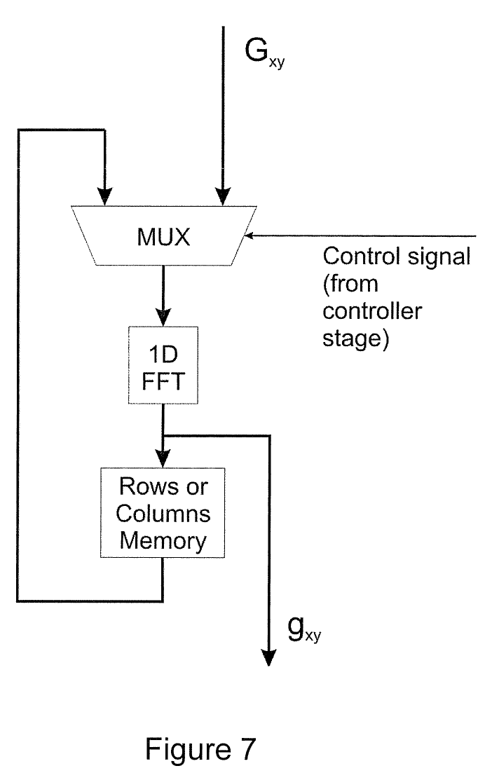

FIG. 7 shows an embodiment of hardware which performs a 2-D FFT on incoming phase-modulated image data, G_{xy}, as shown in FIG. 2. In this embodiment, the hardware required to perform the 2-D FFT operation comprises a 1-D FFT block, a memory element for storing intermediate row or column results, and a feedback path (which may incorporate a scaling factor) from the output of the memory to one input of a multiplexer. The other input of this multiplexer is the phase-modulated input image data, G_{xy}, and the control signal to the multiplexer is supplied from a controller block as shown in FIG. 2. Such an embodiment represents an area-efficient method of performing a 2-D FFT operation.

In some implementations of an OSPR-type algorithm the input image is padded with zeros around the edges to create an enlarged image plane prior to performing a holographic transform, for example, so that the transformed image fits the SLM (for more details see co-pending UK patent application no, 0610784.1 filed 2 Jun. 2006, hereby incorporated by reference in its entirety. In such a case when performing an (I)FFT the zeros (more precisely, the zeroed areas) may be omitted to speed up the processing.

Further details of an example embodiment of the system are described below:

### Example Hardware OSPPR Holographic Image Display System

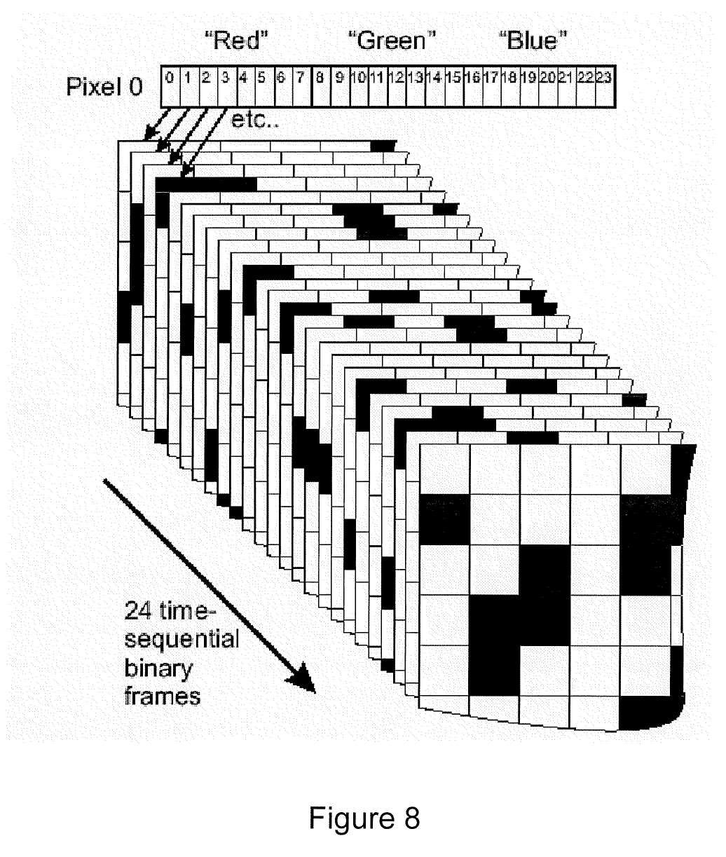

In this example, the holograms (OSPR frames) were displayed on an SXGA (1280×1024) reflective binary phase modulating spatial light modulator (SLM) made by CRL Opto. The SLM was driven by CRL Opto's custom interface board, taking either a DVI or a digitised VGA signal. The native signal was a 1280×1024 60 Hz, 8 bits per colour plane signal, yielding a total of 24 bits. This signal was interpreted as 24 individual binary planes which were displayed sequentially on the SLM at a rate of 1440 frames per second. FIG. 8 shows sequential interpretation of the RGB bitplanies.

This was well suited to an N=24 implementation of OSPR (although N=16 provides a good projected image). A VGA signal, as described above, was provided from an FPGA development board.

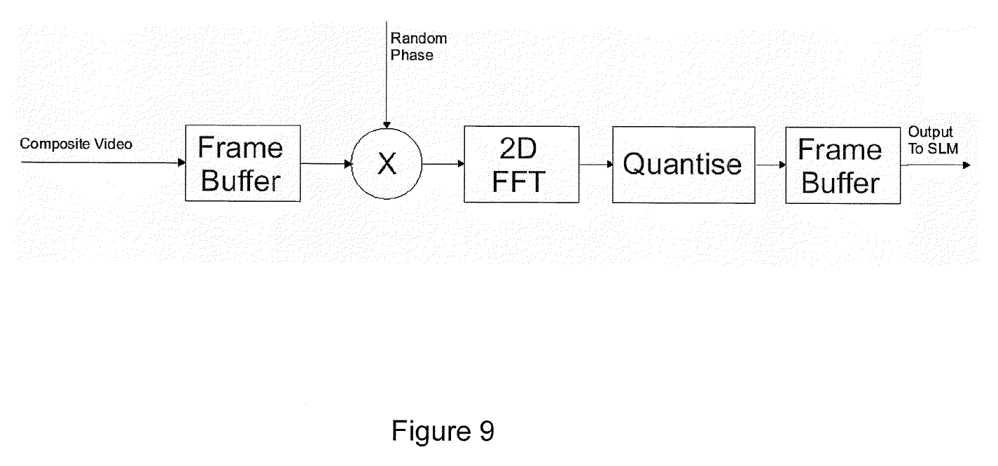

In a constructed embodiment the FPGA development board used to implement the algorithm comprised a Virtex-II (xc2v2000-ff896) Multimedia and Microblaze demonstration board of Xilinx Inc. The Xilinx ISE Foundation software was used to synthesise and implement the design from a Verilog entry. The board was programmed with the Xilinx Parallel Cable TV, and Chipscope Integrated Logic Analyser (ILA) cores were inserted for the process of debugging. FIG. 9 shows an outline block diagram of this system. The demonstration board additionally had built in to it a NTSC/PAL video decoder with 10-flit CCIR656 output (an Analog Devices ADV7185), five separate banks of NtRAM (No Turnaround Random Access Memory; one access per clock cycle reading or writing) (Samsung K7N163601M) and a triple video digital to analog converter (a Fairchild Semiconductor FMS3810) with a SVGA output. The NtRAMs were used for the frame buffers, and the FPGA was used for the two-dimensionial FFT and for the thresholding.

### The Fourier Transform Core

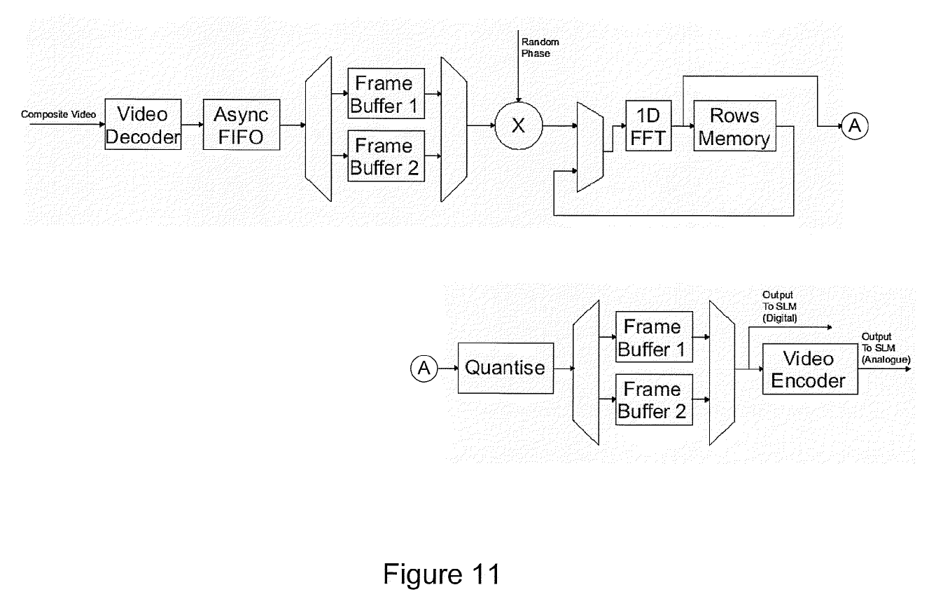

FIG. 11 shows a detailed block diagram of this embodiment of the system. The system was designed completely from a Verilog entry. The system incorporates hardware for a two-dimensional Fourier transform. In order to produce a 1024×1024 hologram, this was implemented by using a single 1024-point, 16-bit precision Fourier transform core. This core was chosen for its streaming capability; i.e. the transform length was only 1024 clock cycles (however the latency is somewhat greater—over 1,800 clock cycles). A two-dimensional Fourier transform can be realized by transforming the rows and the columns:

$$\begin{matrix}F ( u , v ) = \frac{1}{\sqrt{MN}} {\sum }_{x = 0}^{M - 1} {\sum }_{y = 0}^{N - 1} f ( x , y ) {e}^{- j 2 π ( x u / N + yv / M )} \\ = \underbrace{{\sum }_{x = 0}^{M - 1} \underbrace{( {\sum }_{y = 0}^{N - 1} f ( x , y ) {e}^{- j 2 π xu / N} )}_{rows} {e}^{- j 2 π y v / M}}_{… then columns}\end{matrix} \qquad ( 1 )$$

Whether or not a Fast Fourier Transform (FFT) is used, a two-dimensional transform may still be achieved by splitting into rows then columns. Given that the FFT supports streaming, a complete two dimensional Fourier transform using 1D 1024-point transforms therefore takes 2π² clock cycles, plus the latency: i.e. for a clock running at 108 Mhz (for reasons described later), a complete 1024×1024 transform takes 19.5 ms, or it can be run at a maximum frequency (with this example hardware) of just over 50 Hz.

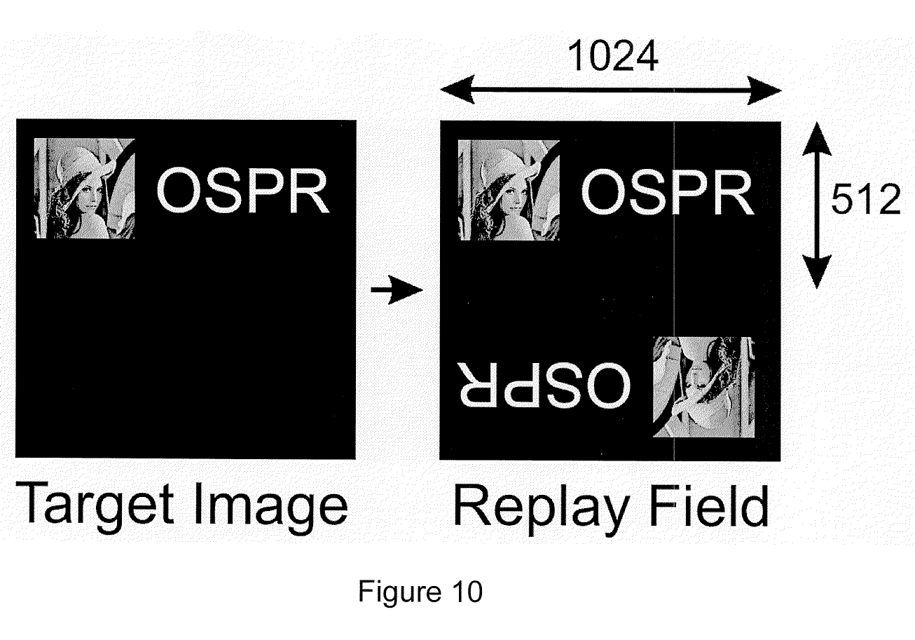

In the present application, a shortcut may be taken when one bears in mind that for any binary hologram, a conjugate image is produced. FIG. 10 shows an example of a replay field including such a conjugate image. For a 1024×1024 hologram, only possible 1024×512 target replay field pixels are used. Therefore (in this particular example) only 512 rows need to be transformed as the Fourier transform of 0 is 0. All 1024 columns should, however; be transformed. The number of operations is hence reduced to

$$\frac{{n}^{2}}{2} + {n}^{2} = \frac{3}{2} {n}^{2}$$

or a total 14.6 ms transform time, or about 69 Hz. For an implementation, N=24 this yields a maximum frame-rate of 5.72 fps (frames per second), and for N=16 a frame-rate of 8.57 fps, as a single Fourier transform produces two frames. For full frame rate video (at least 25 fps) either more FFT cores may be provided in parallel on the FPGA, or the core can be clocked at a higher speed, or a lower value of N can be employed.

### The Quantisation Stage

A median quantisation process for both the real and the imaginary outputs of the Fourier transform. This helps to ensure the overall DC balancing. Median quantisation, however, generally requires all values to be known before the middle value can be found, so that all values can be quantised to (1, −1) based on which side they are of the median value.

To implement this in an FPGA could cause a bottleneck since it would require one pass to find the median of the data before the quantisation stage. Also, all 1024×1024 16-bit real and imaginary values would have to be stored to be compared with the median. This would require an additional 1024×1024×2=2097152 clock cycles, or 19.4 ms if running at 108 MHz. Two work-around possibilities are:
1) To simply quantise around 0
2) To quantise around the last frame's median value, assuming that the last frame should be similar to the current frame in content.

Both of these methods can be very easily pipelined: (1) is easily implemented by simply storing the sign-bit of the output of the FFT; and (2) can be pipelined by storing preferably all the last frames FFT output values, and sorting them while the current frame is being calculated.

For versions of simplicity, and because only a limited amount of memory was available on board, method (1) was chosen for the described example embodiment.

### The Phase Randomiser

This was implemented using a CORDIC (Coordinate rotation digital computer) core. The selected core also had an in-built scale compensator to compensate for the increase in magnitude caused by the CORDIC algorithm. The 8-bit image greyscale magnitudes were simply fed in to the core, along with random numbers generated from an XORshift register. A 16-bit CORDIC core was used for greater precision (with the magnitudes being fed to bits [15-7] (Bit 16 is the sign bit, and hence for images in this example it will always be 0).

### Output Collater

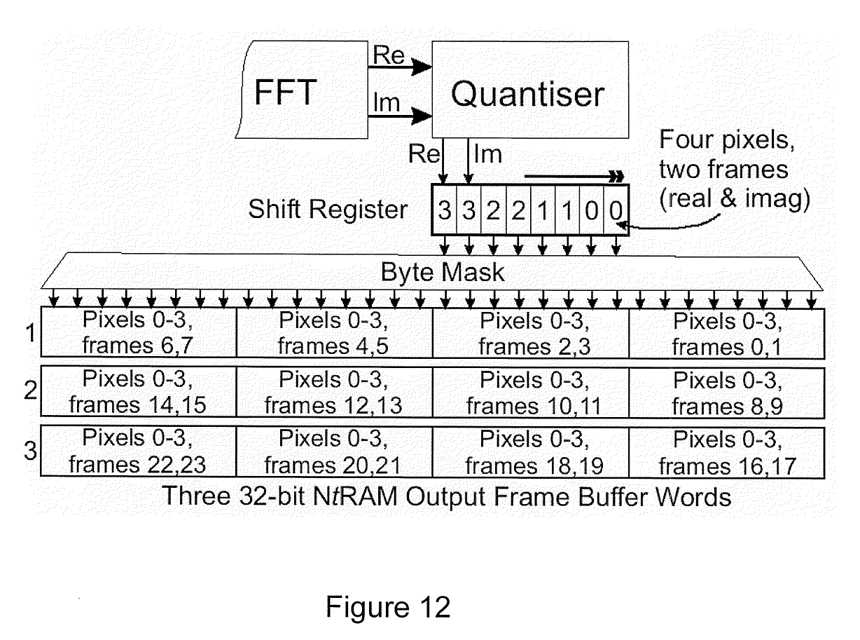

In order to store all the data for multiple OSPR frames in the finite amount of memory available, the output from the quantiser was collated. The NtRAMs, whose data width is 32 bits, have the facility to enable the data to be written by individual bytes. The single bits from the quantiser (both real and imaginary) were put in to a one-byte sized shift register. Every four cycles (hence one complete shift through the shift register), this byte-sized shift register was written to memory using a byte-mask. This procedure is shown in FIG. 12. This was repeated NC times; for example, for a value of N=24, twelve bytes were written (i.e. three 32-bit words).

### Frame Buffers

Two dual-memory frame buffers were implemented in the system. Essentially they were composed of two NtRAMs, one being written to while the other read. A single-bit input to the dual-memory frame buffer configured which NtRAM was being written to, hence giving the ability to be able to switch between the two RAMs.

The output frame buffer was read continuously by the video DAC for the output SVGA signal, while data was written to it by the collated outputs of the FFT.

The input frame buffer had data supplied from the input image FIFO (first-in and first-out) buffer, while data was read in to the phase randomiser.

### Video Input

An Analog Devices ADV7185 (NTSC/PAL video decoder) was used to decode a composite video signal.

In order to configure the device via the I²C bus standard, a simple microprocessor was implemented in the FPGA (KCPSM-II (Constant (K) Coded Programmable State Machine 2, written by Chapman, K. of Xilinx Inc.)). The ADV7185 was configured to give 10-bit luminance data interleaved by the two chrominance channels (YUV data) as a 27 MHz data stream: Cb₀Y₀Cr₀Y₁Cb₂Y₂Cr₂Y₃Cb₄Y₄Cr₄Y₅ . . . (This data stream is a ‘4:2:2’ sampling scheme, where there are only chrominance values for every other luminance value). This data was fed into a line-field decoder in order to find the line timing signals, signals embedded in the data through the use of reserved data words used as timing reference signals (TRS) (see International Telecommunication Union video standards JTU-R BT.656 and ITU-R BT.601).

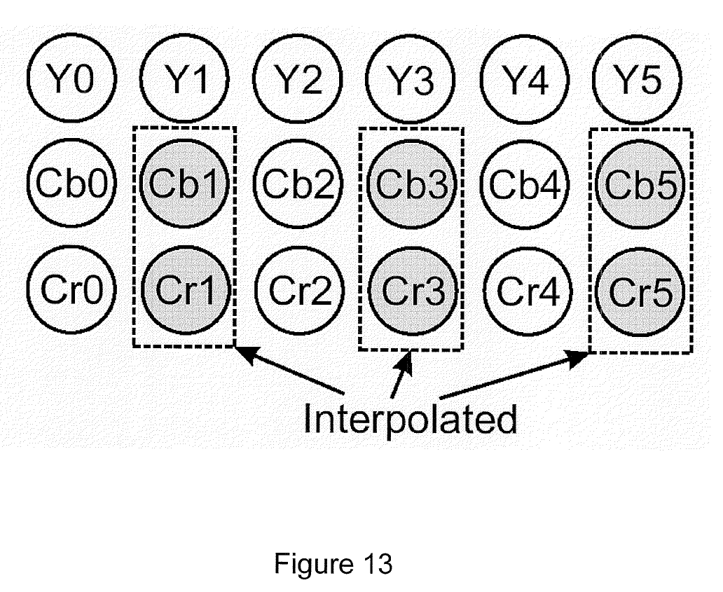

The data stream was then converted from the 4:2:2 scheme to a 4:4:4 scheme by interpolating between the chrominance values, (this is shown in FIG. 13). For only one colour channel (in this instance we were only taking the luminance) this stage is not required; however it is used should the system be extended to full-colour RGB operation (a colour space converted may also be used to change from YU-V to RGB data).

The next stage was a de-interlacing stage. The method chosen to de-interlace was ‘Multiple Field Processing’. The two fields (odd and even) were stored together in memory to form a single frame (sometimes referred to as ‘weave’). This was achieved by having an address counter that stored the odd and even frames together. This method of de-interlacing produced the highest resolution output picture, but sometimes had undesirable visual artifacts (double imaging) when the image had significant movement (for example, the image may have changed significantly after the odd field was sent, before the even field is sent). Another alternative is to interpolate between the lines of each frame.

As the timing of the luminance data was not regular, the data was fed in to a FIFO buffer before being stored in the NtRAM. Another FIFO was placed in parallel with this and was fed with the address of the luminance value being stored, in order to de-interlace the signal.

### SVGA Output

The FPGA supplied the triple video D/A converter (the FMS3815) with three channels of 8-bit data (decoded by the CRL Opto board into 24 sequential binary frames). The CRL Opto display device had a native resolution of 1280×1024. Standard values for the sync timings and borders were chosen for this resolution, and a clock of 108 MHz was used (hence the rest of the system was run at 108 MHz for simplicity). As the data had been collated within the FPGA by the ‘output collater’ module, the data had to be ‘unpacked’ before being sent to the FMS3815.

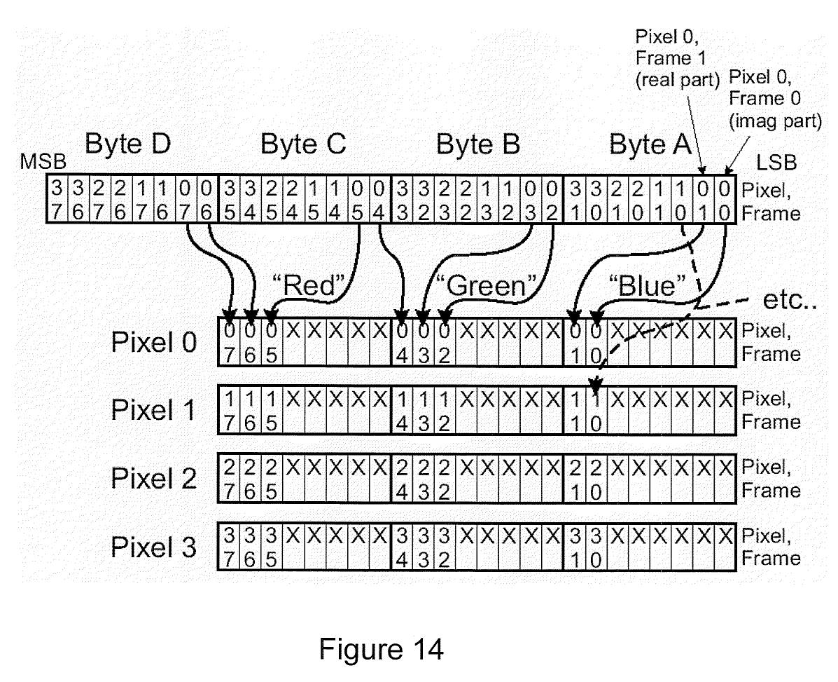

FIG. 14 shows an example of displaying the collated data where N=8. In this implementation, there is enough space in one 32-bit word to cover 8 frames for 4 pixels. If a higher N were required, then several 32-bit words could be used, for example, an N=24 implementation would use three words. These would be read, and the data shifted in to the ‘red’, ‘green’ and ‘blue’ channels for all four pixels simultaneously (i.e. preferably the process is pipelined, to avoid a bottleneck, instead merely having a latency).

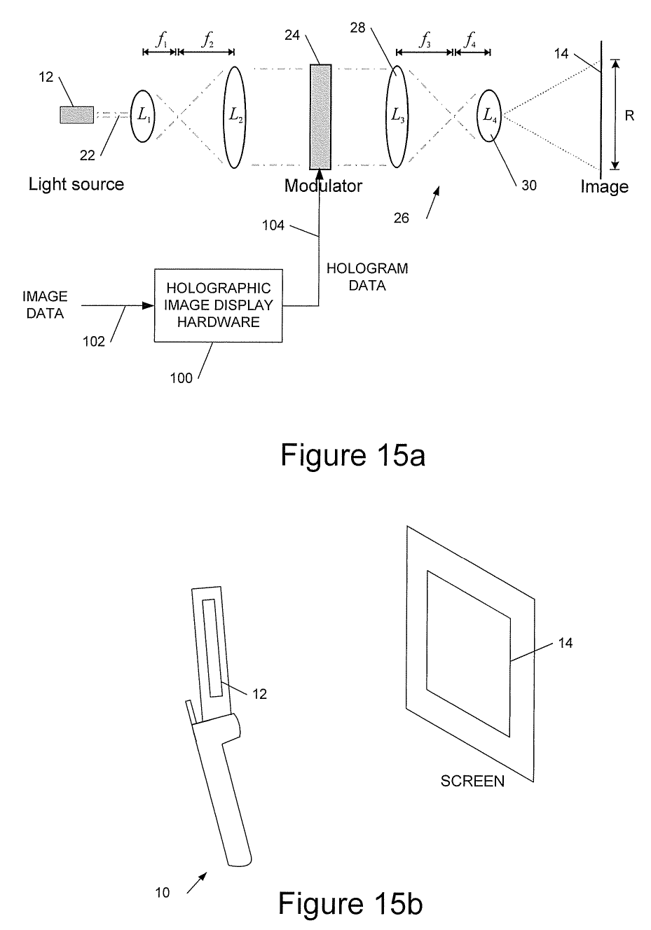

FIG. 15a shows a holographic image display system incorporating a hardware accelerator 100 as described above. The hardware accelerator 100 has an input 102 to receive image data, for example from a consumer electronic device defining an image to be displayed. The hardware accelerator 100 drives SLM 24 to project a plurality of phase hologram sub-frames which combine to give the impression of displayed image 14 in the replay field (RPF).

In more detail, a laser diode 20 (for example, at 532 nm), provides substantially collimated light 22 to a spatial light modulator 24 such as a pixilated liquid crystal modulator. The SLM 24 phase modulates light 22 with a hologram and the phase modulated light is provided to a demagnifying optical system 26. In the illustrated embodiment, optical system 26 comprises a pair of lenses 28, 30 with respective focal lengths f₁, f₂, f₁<f₂, spaced apart at distance f₁+f₂. Optical system 26 (which is not essential) increases the size of the projected holographic image by diverging the light forming the displayed image, as shown.

Lenses L₁ and L₂ (with focal lengths f₁ and f₂ respectively) form the beam-expansion pair. This expands the beam from the light source so that it covers the whole surface of the modulator. The skilled person will understand that depending on the relative size of the beam 22 and SLM 24 this may be omitted. Lens pair L₃ and L₄ (With focal lengths f₃ and f₄ respectively) form a demagnification lens pair, in effect a demagnifying telescope. This effectively reduces the pixel size of the modulator, thus increasing the diffraction angle. As a result, the image size increases. The increase in image size is equal to the ratio of f₃ to f₄, which are the focal lengths of lenses L₃ and L₄ respectively. The skilled person will understand that other optical arrangements can also be used to achieve this effect. In embodiments a filter may also be included to filter out unwanted parts of the displayed image, for example a bright (zero order) undiffracted spot or a repeated first order or conjugate image, which may appear as an upside down version of the displayed image, depending upon how the hologram for displaying the image is generated. Optionally one or more lenses may be encoded in the hologram, as described in UK patent application GB 0606123.8 filed on 28 Mar. 2006, hereby incorporated by reference in its entirety, allowing the size of the optical system to be reduced.

In a colour system light beams from red, green and blue lasers may be combined and modulated by a common SLM (time multiplexed). Techniques for implementing a colour display are described in more detail in UK patent application GB 0610784.1 filed on 2 Jun. 2006, also incorporated by reference in its entirety.

FIG. 15b shows an example a consumer electronic device 10 incorporating a hardware projection module 12 as described above to project a displayed image 14.

We have described an embodiment of holographic image display hardware which is configured to implement a procedure in which a two-dimensional image is generated using a plurality of holographically generated temporal subframes, the temporal subframes being displayed sequentially in time such that they are perceived as a single reduced-noise image. We have described an example procedure which we broadly refer to as One Step Phase Retrieval (OSPR), We have, however, also described OSPR-type procedures in which, strictly speaking, in some implementations it could be considered that more than one step is employed. The holographic image display hardware we have described is also suitable for implementing these procedures, examples of which are described in GB0518912.1 filed 16 Sep. 2005 and GB0601481.5 filed on 25 Jan. 2006, both hereby incorporated by reference in their entirety.

Broadly speaking, in the first of the above two patent applications “noise” in one sub-frame is compensated in a subsequent sub-frame so that the number of subframes required for a given image quality can be reduced. More particularly feedback is used so that the noise of each subframe compensates for the cumulative noise from previously displayed subframes. In the second, by calculating the holographic subframe data at a higher resolution than is used to display a subframe, phase-induced errors can be compensated by adjusting the target phase data for pixels of the image to compensate for the errors introduced. Preferably this is performed so that the desirable requirement of a substantially flat spatial spectrum is met.

Applications for the above described holographic image display hardware include, but are not limited to, the following: mobile phone; PDA; laptop; digital camera; digital video camera; games console; in-car cinema; personal navigation systems (in-car or wristwatch GPS); head-up/helmet-mounted displays for automobiles or aviation; watch; personal media player (e.g. MP3 player, personal video player); dashboard mounted display; laser light show box; personal video projector (a “video iPod®”); advertising and signage systems; computer (including desktop); and a remote control unit.

No doubt many other effective alternatives will occur to the skilled person. It will be understood that the invention is not limited to the described embodiments and encompasses modifications apparent to those skilled in the art lying within the spirit and scope of the claims appended hereto.

1. A hardware accelerator for a holographic image display system, the image display system being configured to generate a displayed image using a plurality of holographically generated temporal subframes, said temporal subframes being displayed sequentially in time such that they are perceived as a single reduced-noise image, each said subframe being generated holographically by modulation of a spatial light modulator with holographic data such that replay of a hologram defined by said holographic data defines a said subframe, the hardware accelerator comprising:
an input buffer to store image data defining said displayed image;
an output buffer to store holographic data for a said subframe;
at least one hardware data processing module coupled to said input data buffer and to said output data buffer to process said image data to generate said holographic data for a said subframe; and
a controller coupled to said at least one hardware data processing module to control said at least one data processing module to provide holographic data for a plurality of said subframes corresponding to image data for a single said displayed image to said output data buffer.

2. A hardware accelerator as claimed in claim 1 comprising a plurality of said hardware data processing modules each coupled to said input data buffer and to said output data buffer to process said image data to generate said holographic data for a plurality of said subframes in parallel.

3. A hardware accelerator as claimed in claim 1 wherein said image data comprises data for a plurality of pixels of said displayed image, and wherein said hardware data processing module comprises: a phase modulator coupled to said input data buffer and having a phase modulation data input to modulate phases of said image data pixels in response to phase modulation data from said phase modulation data input; a space-frequency transformation module coupled to an output of said phase modulator to perform a transformation of a spatial distribution of said phase modulated image data and output holographic subframe data; and a quantiser coupled to said transformation module output to quantise said holographic subframe data to provide said holographic data for a subframe for said output buffer.

4. A hardware accelerator as claimed in claim 3 wherein said phase modulator comprises at least one multiplier having inputs coupled to said input data buffer and to said phase modulation data input and an output coupled to said space-frequency transformation module.

5. A hardware accelerator as claimed in claim 4 further comprising a random phase data module having an output coupled to said phase modulation data input to provide at least partially random phase data for modulating said input data pixels.

6. A hardware accelerator as claimed in claim 3, wherein said space-frequency transformation module comprises a Fourier transformation or inverse Fourier transformation module to perform a two-dimensional transform of said phase modulated image data.

7. A hardware accelerator as claimed in claim 6 wherein said space-frequency transformation module comprises a one-dimensional Fourier transformation module with feedback.

8. A hardware accelerator as claimed in claim 3 wherein said quantiser is configured to quantise real and imaginary components of said holographic subframe data to generate holographic data for a pair said subframes for said output buffer.

9. A hardware accelerator as claimed in claim 1 wherein one or both of said input and output buffers comprise dual-ported memory.

10. A hardware accelerator as claimed in claim 1 wherein the holographic image display system comprises a video image display system, and wherein said displayed image comprises a video frame.

11. A holographic image display system configured to generate a displayed image using a plurality of holographically generated temporal subframes, said temporal subframes being displayed sequentially in time such that they are perceived as a single reduced-noise image, each said subframe being generated holographically by modulation of a spatial light modulator with holographic data such that replay of a hologram defined by said holographic data defines a said subframe; including the accelerator of any preceding claim.

12. A holographic image display system incorporating a hardware accelerator as claimed in claim 1.

13. A consumer electronic device incorporating a holographic image display system as claimed in claim 11.

14. A head-up or helmet-mounted display incorporating a holographic image display system as claimed in claim 11.
